(19) United States
(12) Patent Application Publication
(10) Pub. No.: US 2015/0332085 A1
(43) Pub. Date: Nov. 19, 2015

(54) METHOD AND SYSTEM FOR ADAPTIVE ADJUSTMENT OF TERMINAL

(71) Applicant: Looq System Inc, Santa Clara, CA (US)

(72) Inventor: Woody Yu, Santa Clara, CA (US)

(73) Assignee: Looq System Inc, Santa Clara, CA (US)

(21) Appl. No.: 14/277,135

(22) Filed: May 14, 2014

(51) Int. Cl. G06K 9/00; G06F 3/00; H04N 5/44; G06F 3/01

(52) U.S. Cl. CPC G06K 9/00255; G06F 3/013; G06F 3/012; G06F 3/005; G06K 9/00604; H04N 5/4403

(57) ABSTRACT

The present invention relates to the technical field of smart household electric appliances and discloses a method and system for adaptive adjustment of a terminal. The method comprises the steps of: capturing in real time a current image of a user; evaluating based on the image a current use state of the user and a duration of the use state; performing an automatic control of the terminal based on the use state and its duration. According to the present invention, the user's current use state with respect to an electronic terminal is automatically detected through image identification, and based on the information on the state duration, the electronic terminal is controlled to perform a targeted adjustment, thereby achieving not only effective energy-saving, but also facilitation of user operation and enhancement of user experience.

### TECHNICAL FIELD OF THE INVENTION

The present invention relates to the technical field of smart household electric appliances, and more particularly to a method and system for adaptive adjustment of a terminal

### DESCRIPTION OF THE RELATED ART

With the continuous improvement of people's living standard, terminal devices such as TVs, ipads, computers, mobile phones and the like have become an indispensable part of people's lives. However, many people use terminal devices such as televisions etc primarily as a pastime, and in the course of use, they often unknowingly fall asleep and forget to turn off televisions or computers etc., thereby causing waste of electricity. Moreover, when a user has just fallen asleep, there may be a possibility that a higher volume of the television would wake the user, thus affecting the quality of sleep and causing a great plague to the user. Also sometimes, when people are watching TV, they would possibly encounter some unexpected events. This forces them to deal with emergencies immediately without time to turn off the television, so that the television has been turned on with a possible great sound, causing waste of electricity.

Although existing televisions have a turning-off timing function, this function does not take into account whether a user continues to use the television, so that it is impossible to automatically choose whether to turn off the television based on flexibly the state of the user's real-time viewing. If the user does not select the turning-off timing, even if the user leaves, the television has been turned on, that is to say, if the user has previously set the turning-off timing, even if the time is up, when the user is fascinated and wants to continue watching, the television will be forced to turn off or has to be set again, disappointing the user.

### SUMMARY

In view of the aforementioned disadvantages of the prior art, the present invention provides a method for adaptive adjustment of a terminal, comprising the steps of: capturing in real time a current image of a user; evaluating based on the image a current use state of the user and a duration of the use state; performing an automatic control of the terminal based on the use state and its duration.

Preferably, the evaluation further comprises the steps of:
identifying from the current image the image information on a specific face zone of the user;
judging from the image information whether the user is in the normal use state, and evaluating based on the previous judgment result the duration of the state.

Preferably, the automatic control further comprises the following:
if the user is in the abnormal use state and the duration is lower than a preset threshold value, then the volume of the terminal is reduced and the counter value is increased by one;
if the user is in the abnormal use state and the duration reaches or exceeds the preset threshold value, then the terminal is turned off;
if the user is in the normal use state and the counter value is not zero, then the volume of the terminal is raised and the counter value is decreased by one;
if the user is in the normal use state and the counter value is zero, then no adjustment of the terminal is performed.

Preferably, if the user's eyes open normally, then the user is in the normal use state; if the user' eyes close, then the user is in the abnormal use state.

Preferably, the threshold value is five minutes, and the initial value of the counter when it is turned on at the terminal is zero.

In accordance with another aspect of the present invention, there is further proposed a system for adaptive adjustment of a terminal, comprising:
an image capturing module for capturing in real time a current image of a user;
a state evaluation module for evaluating based on the image a current use state of the user and a duration of the use state;
an adjustment module for performing an automatic control of the terminal based on the use state and its duration.

Preferably, the system is disposed outside the terminal, or disposed in an integrated manner inside the terminal.

Preferably, the state evaluation module further comprises:
an identification module for identifying from the current image an image information on a specific face zone of the user;
an judgment module for judging from the image information whether the user is in the normal use state, and evaluating based on the previous judgment result the duration of the state.

Preferably, the automatic control module further comprises a timer and a counter, wherein,
if the user is in the abnormal use state and the duration is lower than a preset threshold value of the timer, then the volume of the terminal is reduced and the counter value is increased by one;
if the user is in the abnormal use state and the duration reaches or exceeds the preset threshold value of the timer, then the terminal is turned off;
if the user is in the normal use state and the counter value is not zero, then the volume of the terminal is raised and the counter value is decreased by one;
if the user is in the normal use state and the counter value is zero, then no adjustment of the terminal is performed.

Preferably, when the system is disposed outside the terminal, the adjustment module performs in a remote control manner the automatic control.

Compared to the prior art, according to the technical solution of the present invention, there is proposed a method for adaptive adjustment of a terminal, wherein, the user's current use state with respect to an electronic terminal is automatically detected through image identification, and based on the information on the state duration, the electronic terminal is controlled to perform a targeted adjustment (volume adjustment or turning-off operation, etc. for example), thereby achieving not only effective energy-saving, but also facilitation of user operation and enhancement of user experience.

### BRIEF DESCRIPTION OF THE DRAWINGS

FIG. 1 is a schematic flow diagram of a method for adaptive adjustment of a terminal in an embodiment of the present invention;

FIG. 2 is a schematic detailed flow diagram of a method for adaptive adjustment of a terminal in a preferred embodiment of the present invention;

FIG. 3 is a schematic modular structural diagram of a system for adaptive adjustment of a terminal in an embodiment of the present invention;

### DETAILED DESCRIPTION OF EMBODIMENTS

Certain terms are used throughout the description and the following claims to refer to particular components. As one skilled in the art will appreciate, hardware manufacturers may refer to a component by different names. This document does not intend to distinguish between components that differ in name but not function. Furthermore, the term “couple” is herein intended to mean either an indirect or a direct electrical coupling. Accordingly, if one device is coupled to another device, then it means that the one device may directly electrically coupled to or indirectly through other devices or coupling means electrically coupled to the another device. The embodiments described hereinafter are the preferred embodiments for implementing the present invention, and the description herein is for the purpose of explaining the general principles of the present invention and is not intended to limit the scope of the present invention. The protection scope of the present invention should be as defined in the appended claims.

Hereinafter, the present invention will be described in further detail in connection with the accompanying drawings, but this description herein is not intended to limit the present invention.

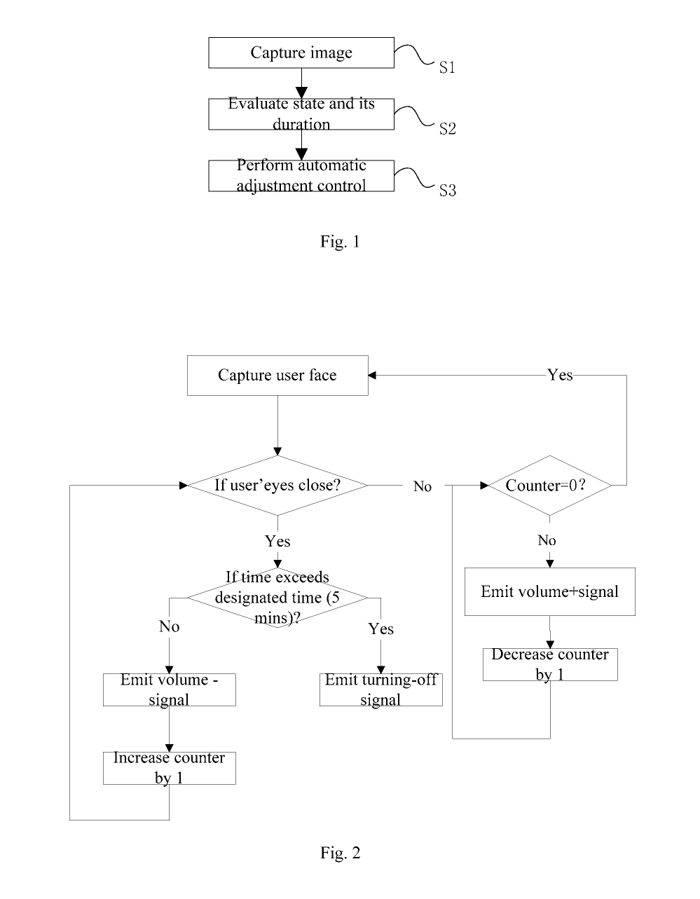

As shown in FIG. 1, a method for adaptive adjustment of a terminal in an embodiment of the present invention comprises the steps of:

S1 capturing in real time a current image of a user;

S2 evaluating based on the image a current use state of the user and a duration of the use state;

S3 performing an automatic control of the terminal based on the use state and its duration.

Wherein, the current image is the image data obtained after the situation within the effective use range of the terminal is acquired.

Referring further to FIG. 2, in a preferred embodiment of the present invention, the evaluation at step 2 further comprises the steps of:
identifying from the current image an image information on a specific face zone of the user; preferably, the specific face zone is the eyes' zone; more preferably, the image information is the information on opening and/or closing of the eyes;
judging from the image information whether the user is in the normal use state, and evaluating based on the previous judgment result the duration of the state.

Wherein, if the user's eyes open normally, then the user is in the normal use state; if the user' eyes close, then the user is in the abnormal use state. Preferably, the eyes' normal opening means that the user's iris (or pupil) can be identified from the current image; the eyes' closing means that the user's iris (or pupil) can not be identified from the current image, including the cases in which the user's eyes close or the user leaves, etc.

The automatic control at step 3 further comprises the following:
if the user is in the abnormal use state and the duration is lower than a preset threshold value, then the volume of the terminal is reduced and the counter value is increased by one;
if the user is in the abnormal use state and the duration reaches or exceeds the preset threshold value, then the terminal is turned off;
if the user is in the normal use state and the counter value is not zero, then the volume of the terminal is raised and the counter value is decreased by one;
if the user is in the normal use state and the counter value is zero, then no adjustment of the terminal is performed.

Preferably, the threshold value is five minutes, and the initial value of the counter when it is turned on at the terminal is zero.

Ordinary skill in the art can understand that implementation of the whole or part of the steps in the method of the above embodiments can be achieved by giving instructions to the relevant hardware through a program, which can be stored in a computer readable storage medium. When being executed, the program includes all the steps in the method of the above embodiments. The storage medium may be ROM/RAM, disk, CD-ROM, or memory card, etc.

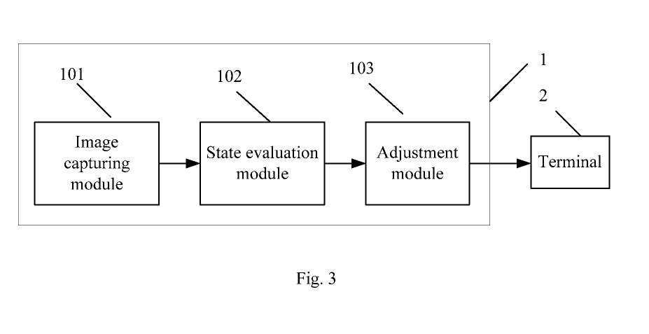

Accordingly, referring to FIG. 3, corresponding to the above method, the present invention also discloses a system 1 for adaptive adjustment of a terminal, comprising:
an image capturing module 101 for capturing in real time a current image of a user;
a state evaluation module 102 for evaluating based on the image a current use state of the user and a duration of the use state;
an adjustment module 103 for performing an automatic control of the terminal 2 based on the use state and its duration.

Wherein, the terminal includes, but is not limited to, television, computer, tablet computer, mobile phone, etc. The system may be disposed outside the terminal, or disposed in an integrated manner inside the terminal Preferably, when the system is disposed outside the terminal, the adjustment module performs in a remote control manner the automatic control.

The image capturing module (preferably camera, etc) is coupled to the state evaluation module and offers an image captured in real time to the state evaluation module. The state evaluation module is a data processing unit, which extracts and identifies the image to obtain a judgment result, and which preferably identifies the zone of the user's eyes. Of course, it is also possible to detect image information (user expression, etc. for example) on other face zones of the user, or data information (user gesture, etc. for example) on other body parts of the user and to judge from the said information the user state. Here, there is no limit to the particular embodiments of the present invention. Preferably, the image capturing module performs a capturing action every a predetermined period of time. Furthermore, the adjustment module reduces or raises the volume every time by a same intensity increment.

Compared to the prior art, according to the technical solution of the present invention, there is proposed a method for adaptive adjustment of a terminal, wherein, the user's current use state with respect to an electronic terminal is automatically detected through image identification, and based on the information on the state duration, the electronic terminal is controlled to perform a targeted adjustment (volume adjustment or turning-off operation, etc. for example), thereby achieving not only effective energy-saving, but also facilitation of user operation and enhancement of user experience.

The above description illustrates and describes the certain preferred embodiments of the present invention. However, as described hereinabove, it should be understood that, the present invention is not limited to the form disclosed herein, should not be seen as excluding other embodiments, can be used in a variety of other combinations, modifications and environments, and is capable of being changed within the scope of the invention described herein through the above teachings or related zones of technology or knowledge. Any changes and variations made by persons of ordinary skill in the art without departing from the spirit and scope of the present invention should be inside the protection scope defined in the appended claims of the present invention.

1. A method for adaptive adjustment of a terminal, characterized in that the method comprises the steps of:
capturing in real time a current image of a user;
evaluating based on the image a current use state of the user and a duration of the use state;
performing an automatic control of the terminal based on the use state and its duration.

2. The method according to claim 1, characterized in that the evaluation further comprises the steps of:
identifying from the current image an image information on a specific face zone of the user;
judging from the image information whether the user is in the a normal use state, and evaluating based on the previous judgment result the duration of the state.

3. The method according to claim 1, characterized in that performing the automatic control further comprises the following:
if the user is in an abnormal use state and the duration is lower than a preset threshold value, then the volume of the terminal is reduced and the counter value is increased by one;
if the user is in the abnormal use state and the duration reaches or exceeds the preset threshold value, then the terminal is turned off;
if the user is in the normal use state and the counter value is not zero, then the volume of the terminal is raised and the counter value is decreased by one;
if the user is in the normal use state and the counter value is zero, then no adjustment of the terminal is performed.

4. The method according to claim 3, characterized in that if the user's eyes open normally, then the user is in the normal use state; if the user' eyes close, then the user is in the abnormal use state.

5. The method according to claim 3, characterized in that the threshold value is five minutes, and the initial value of the counter when it is turned on at the terminal is zero.

6. A system for adaptive adjustment of a terminal, characterized in that the system comprises:
an image capturing module for capturing in real time a current image of a user;
a state evaluation module for evaluating based on the image a current use state of the user and a duration of the use state;
an adjustment module for performing an automatic control of the terminal based on the use state and its duration.

7. The system according to claim 6, characterized in that the system is disposed outside the terminal, or disposed in an integrated manner inside the terminal.

8. The system according to claim 6, characterized in that the state evaluation module further comprises:
an identification module for identifying from the current image an image information on a specific face zone of the user;
an judgment module for judging from the image information whether the user is in a normal use state, and evaluating based on the previous judgment result the duration of the state.

9. The system according to claim 6, characterized in that the automatic control module further comprises a timer and a counter, wherein,
if the user is in an abnormal use state and the duration is lower than a preset threshold value of the timer, then the volume of the terminal is reduced and the counter value is increased by one;
if the user is in the abnormal use state and the duration reaches or exceeds the preset threshold value of the timer, then the terminal is turned off;
if the user is in the normal use state and the counter value is not zero, then the volume of the terminal is raised and the counter value is decreased by one;
if the user is in the normal use state and the counter value is zero, then no adjustment of the terminal is performed.

10. The system according to claim 7, characterized in that when the system is disposed outside the terminal, the adjustment module performs in a remote control manner the automatic control.
